(19) United States
(12) Patent Application Publication
(10) Pub. No.: US 2023/0093177 A1
(43) Pub. Date: Mar. 23, 2023

(54) OPERATION DEVICE

(71) Applicant: KABUSHIKI KAISHA TOKAI-RIKA-DENKI-SEISAKUSHO, Niwa-gun, Aichi (JP)

(72) Inventors: Naofumi KATO, Niwa-gun, Aichi (JP); Masanori KOSUGI, Niwa-gun, Aichi (JP); Hitoshi MURAKI, Niwa-gun, Aichi (JP); Tetsuya EGAWA, Niwa-gun, Aichi (JP)

(21) Appl. No.: 17/909,227

(22) PCT Filed: Jan. 27, 2021
(86) PCT No.: PCT/JP2021/002861

§ 371 Date: Sep. 2, 2022

(30) Foreign Application Priority Data
Mar. 5, 2020 (JP) 2020-038116

(51) Int. Cl. B62D 1/12; G05G 1/10

(52) U.S. Cl. CPC B62D 1/12; G05G 1/10

(57) ABSTRACT

An operation device includes a first displacement portion that is displaceable by being operated by an occupant of a vehicle, a second displacement portion supported at the first displacement portion, and an extension/retraction locking portion. The second displacement portion is displaceable with respect to the first displacement portion by being operated by an occupant of the vehicle. In a state in which the first displacement portion is positioned at a first position, the extension/retraction locking portion restricts displacement of the second displacement portion with respect to the first displacement portion. In a state in which the first displacement portion is positioned at a second position, the extension/retraction locking portion permits displacement of the second displacement portion with respect to the first displacement portion.

### TECHNICAL FIELD

The present invention relates to an operation device.

### BACKGROUND ART

Japanese Patent Application Laid-Open (JP-A) No. H11-48985 discloses a vehicle steering handle having a handle main body that is rotatably supported, and a pair of left and right grips that are supported at the left and right both ends of the handle main body, respectively. At the vehicle steering handle that is disclosed in the aforementioned publication, when an occupant of the vehicle rotates the vehicle steering handle in a leftward direction in a state of gripping the pair of left and right grips with his/her left hand and right hand respectively, the grip that is gripped by the left hand is swung so as to extend toward the vehicle occupant side with respect to the handle main body. Due thereto, twisting of the left hand of the vehicle occupant at the time of rotating the vehicle steering handle in a leftward direction is suppressed. Similarly, when an occupant of the vehicle rotates the vehicle steering handle in a rightward direction in a state of gripping the pair of left and right grips with his/her left hand and right hand respectively, the grip that is gripped by the right hand is swung so as to extend toward the vehicle occupant side with respect to the handle main body. Due thereto, twisting of the right hand of the vehicle occupant at the time of rotating the vehicle steering handle in a rightward direction is suppressed.

By the way, in a structure having two or more portions that are displaced by being operated by an occupant of a vehicle such as the above-described vehicle steering handle, there are cases in which, at the time of restricting displacement of one of the portions, it is desirable to be able to ensure the amount of displacement of the another portion.

### SUMMARY OF INVENTION

### Technical Problem

In view of the above-described circumstances, an object of the present invention is to provide an operation device that, at the time of restricting displacement of one portion, can ensure the amount of displacement of another portion.

### Solution to Problem

An operation device relating to a first aspect comprises: a first displacement portion that is displaceable by being operated by an occupant of a vehicle; a second displacement portion that is supported at the first displacement portion, and that is displaceable with respect to the first displacement portion by being operated by an occupant of the vehicle; and a locking portion that, in a state in which the first displacement portion is positioned at a first position, restricts displacement of the second displacement portion with respect to the first displacement portion, and, in a state in which the first displacement portion is positioned at a second position, permits displacement of the second displacement portion with respect to the first displacement portion.

In an operation device relating to a second aspect, in the operation device of the first aspect, the first displacement portion is rotatably supported, and the second displacement portion is supported at the first displacement portion so as to be able to be displaced toward the first displacement portion side and a side opposite the first displacement portion.

In an operation device relating to a third aspect, in the operation device of the first aspect, the first displacement portion is tiltably supported, and the second displacement portion is tiltably supported at the first displacement portion.

In an operation device relating to a fourth aspect, the operation device of any one of the first aspect through the third aspect further comprises a first sensor that detects an amount of displacement of the first displacement portion, and a second sensor that detects an amount of displacement of the second displacement portion with respect to the first displacement portion, wherein, in a state in which the first displacement portion is positioned at the second position, values corresponding to an output value of the first sensor and an output value of the second sensor are added together.

### Advantageous Effects of Invention

In accordance with the operation device relating to the first aspect, in the state in which the first displacement portion is positioned at the first position, the locking portion restricts displacement of the second displacement portion with respect to the first displacement portion. Further, in the state in which the first displacement portion is positioned at the second position, the locking portion permits displacement of the second displacement portion with respect to the first displacement portion. In this way, in the operation device relating to the first aspect, in the state in which the first displacement portion is positioned at the second position, the amount of displacement of the second displacement portion with respect to the first displacement portion can be ensured.

In the operation device relating to the second aspect, in the state in which the first displacement portion is positioned at the first position, the locking portion restricts displacement of the second displacement portion with respect to the first displacement portion. Further, in the state in which the first displacement portion is positioned at the second position, the locking portion permits displacement of the second displacement portion with respect to the first displacement portion. Due thereto, in the operation device relating to the second aspect, in the state in which the first displacement portion is rotated and is positioned at the second position, the second displacement portion is displaceable toward the first displacement portion side and the side opposite the first displacement portion, with respect to the first displacement portion.

In the operation device relating to the third aspect, in the state in which the first displacement portion is positioned at the first position, the locking portion restricts displacement of the second displacement portion with respect to the first displacement portion. Further, in the state in which the first displacement portion is positioned at the second position, the locking portion permits displacement of the second displacement portion with respect to the first displacement portion. Due thereto, in the operation device relating to the third aspect, in the state in which the first displacement portion is tilted and is positioned at the second position, the second displacement portion is tiltable with respect to the first displacement portion.

In the operation device relating to the fourth aspect, an object can be controlled by, in the state in which the first displacement portion is positioned at the second position, using a value in which values corresponding to the output value of the first sensor and the output value of the second sensor are added together.

### BRIEF DESCRIPTION OF DRAWINGS

FIG. 1 is a front view illustrating an operation device relating to a first embodiment.

FIG. 2 is a front view illustrating the operation device relating to the first embodiment, and illustrates a state of being rotated 90° to the left side.

FIG. 3 is a front view illustrating the operation device relating to the first embodiment, and illustrates a state in which counterclockwise operation further than the state illustrated in FIG. 2 has been carried out.

FIG. 4 is a front view corresponding to FIG. 3 and illustrating an operation device relating to a second embodiment.

FIG. 5 is a side view illustrating the operation device relating to the second embodiment that is seen from the direction of arrow 5 shown in FIG. 4.

FIG. 6 is a front view illustrating an operation device relating to a third embodiment, and illustrates a state in which counterclockwise operation has been further carried out from the state of being rotated 90° to the left side.

FIG. 7 is a side view illustrating an operation device relating to a fourth embodiment.

### DESCRIPTION OF EMBODIMENTS

### Operation Device 10 Relating to First Embodiment

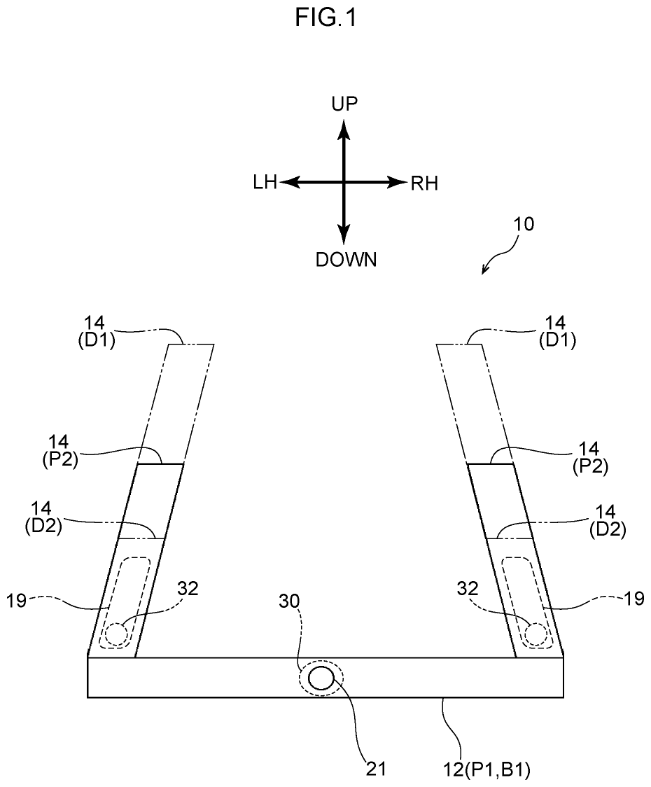

An operation device 10 relating to a first embodiment of the present invention is described by using FIG. 1 through FIG. 3. Note that, when description is given by referring to the longitudinal, left-right and vertical directions in the following explanation, they indicate the longitudinal direction of the vehicle, the left-right direction of the vehicle (the transverse direction of the vehicle), and the vertical direction of the vehicle. Further, arrow FR that is shown appropriately in the respective drawings indicates the frontward direction of the vehicle, arrow UP indicates the upward direction of the vehicle, arrow RH indicates the rightward direction of the vehicle, arrow LH indicates the leftward direction of the vehicle, arrow DOWN indicates the lower side of the vehicle, and arrow RR indicates the rear side of the vehicle, respectively.

As illustrated in FIG. 1, the operation device 10 of the present embodiment has a first displacement portion 12 that can rotate by being operated by an occupant of the vehicle, and a pair of left and right second displacement portions 14 that are supported at the first displacement portion 12 in a state of being able to extend and retract. Further, the operation device 10 has extension/retraction locking portions 19 that serve as locking portions and permit or restrict the extending and retracting of the second displacement portions 14 with respect to the first displacement portion 12.

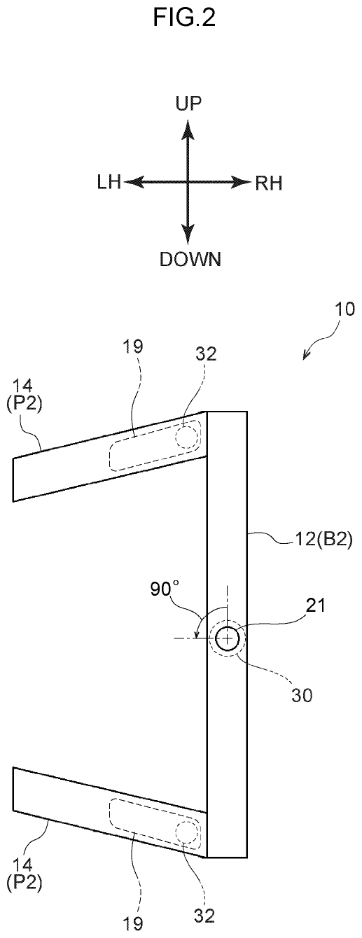

The first displacement portion 12 is formed in the shape of a rectangle whose length direction is the left-right direction. The left-right direction central portion of the first displacement portion 12 is rotatably supported via a shaft 21. Note that the position of the first displacement portion 12, in the state in which the first displacement portion 12 is parallel to the left-right direction, is called neutral position P1. Further, in the present embodiment, the first displacement portion 12 can be rotated within ranges of 90° to the left side (see FIG. 2) from the neutral position P1 and 90° to the right side from the neutral position P1. Namely, it is impossible to rotate the first displacement portion 12 more than 90° to the left side and more than 90° to right side. Note that positions of the first displacement portion 12, which is in a state of being positioned at the neutral position P1, and within the range that is less than 90° to the left side from the neutral position P1, and within the range that is less than 90° to the right side from the neutral position P1, are called restricting position B1 that serves as a first position. Further, the position of the first displacement portion 12, which is in a state of being rotated 90° to the left side from the neutral position or is in a state of being rotated 90° to the right side from the neutral position P1, is called permitting position B2 that serves as a second position.

The one (the left-side) second displacement portion 14 extends from the left-side end portion of the first displacement portion 12 toward the upper side, and is inclined toward the shaft 21 side while heading toward the upper side. Further, the other (the right-side) second displacement portion 14 extends from the right-side end portion of the first displacement portion 12 toward the upper side, and is inclined toward the shaft 21 side while heading toward the upper side. Further, this pair of left and right second displacement portions 14 function as gripping portions that are gripped by the left hand and the right hand of an occupant of the vehicle, respectively.

Further, the pair of left and right second displacement portions 14 are able to extend and retract toward the first displacement portion 12 side and the side opposite the first displacement portion 12 by, as an example, having telescoping mechanisms at the interiors thereof. Note that the second displacement portions 14 that are positioned at neutral positions P2 are illustrated by the solid lines, and the second displacement portions 14, which are at positions D1 of being extended the most and positions D2 of being retracted the most with respect to the first displacement portion 12, are illustrated by the two-dot chain lines, respectively.

The extension/retraction locking portions 19 are, as an example, structured integrally with the telescoping mechanisms that are provided at the interior of the left-side second displacement portion 14 and the interior of the right-side second displacement portion 14, respectively. These extension/retraction locking portions 19 can be switched between two states that are a permitting state and a restricting state due to, as an example, the energization thereof being switched or the like. Further, at the time when the extension/retraction locking portions 19 are in the permitting states, extending and retracting of the second displacement portions 14 with respect to the first displacement portion 12 are permitted. On the other hand, at the time when the extension/retraction locking portions 19 are in the restricting states, extending and retracting of the second displacement portions 14 with respect to the first displacement portion 12 are restricted. Note that the switching between the permitting states and the restricting states of the extension/retraction locking portions 19 may be switching by a mechanical structure and not an electrical structure. Further, in the present embodiment, in the state in which the first displacement portion 12 is positioned at the restricting position B1, the extension/retraction locking portions 19 are in the restricting states. Further, in the state in which the first displacement portion 12 is positioned at the permitting position B2, the extension/retraction locking portions 19 are in the permitting states.

Further, in the present embodiment, the operation device 10 has a first sensor 30 that detects the angle of rotation (the amount of displacement) toward the left side and the right side of the first displacement portion 12, and a pair of left and right second sensors 32 that detect the amounts of extending and retracting (the amounts of displacement) of the pair of left and right second displacement portions 14 with respect to the first displacement portion 12, respectively.

### Operation and Effects of Present Embodiment

Operation and effects of the present embodiment are described next.

As an example, the above-described operation device 10 relating to the present embodiment can be applied to the operations for changing the traveling direction of the vehicle.

As illustrated in FIG. 1, an occupant of the vehicle grips the pair of left and right second displacement portions 14 with his/her left hand and right hand, respectively. Then, in the state in which the occupant of the vehicle is holding the pair of left and tight second displacement portions 14 such that the first displacement portion 12 is at the neutral position P1, the steering angles and the like of the wheels are controlled such that the vehicle travels straight.

Here, in the state in which the first displacement portion 12 is positioned at the restricting position B1, the extension/retraction locking portions 19 are in the restricting states, and extending and retracting of the second displacement portions 14 with respect to the first displacement portion 12 are restricted. In this state, the amount of rotation of the first displacement portion 12 and the amount of movement of the pair of left and right second displacement portions 14 (the amount of movement in the circumferential direction of rotation of the first displacement portion 12) are in a linear relationship, and the first displacement portion 12 is rotated to a position corresponding to the amount of movement of the second displacement portions 14. Specifically, as illustrated in FIG. 1 and FIG. 2, when the occupant of the vehicle inputs operational force to the pair of left and right second displacement portions 14 such that the second displacement portion 14 gripped by the right hand heads toward the upper side and the second displacement portion 14 gripped by the left hand heads toward the lower side, the first displacement portion 12 is rotated toward the left side from the neutral position P1. Then, in a state in which the first displacement portion 12 is positioned within the range of less than 90° toward the left side from the neutral position P1, the steering angles and the like of the wheels toward the left side are controlled so as to become steering angles and the like that correspond to the angle of rotation of the first displacement portion 12 from the neutral position P1 (that are based on the output value from the first sensor 30). On the other hand, when the occupant of the vehicle inputs operational force to the pair of left and tight second displacement portions 14 such that the second displacement portion 14 gripped by the left hand heads toward the upper side and the second displacement portion 14 gripped by the right hand heads toward the lower side, the first displacement portion 12 is rotated toward the right side from the neutral position P1. Then, in a state in which the first displacement portion 12 is positioned within the range of less than 90° toward the right side from the neutral position P1, the steering angles and the like of the wheels toward the right side are controlled so as to become steering angles and the like that correspond to the angle of rotation of the first displacement portion 12 from the neutral position P1 (that are based on the output value from the first sensor 30).

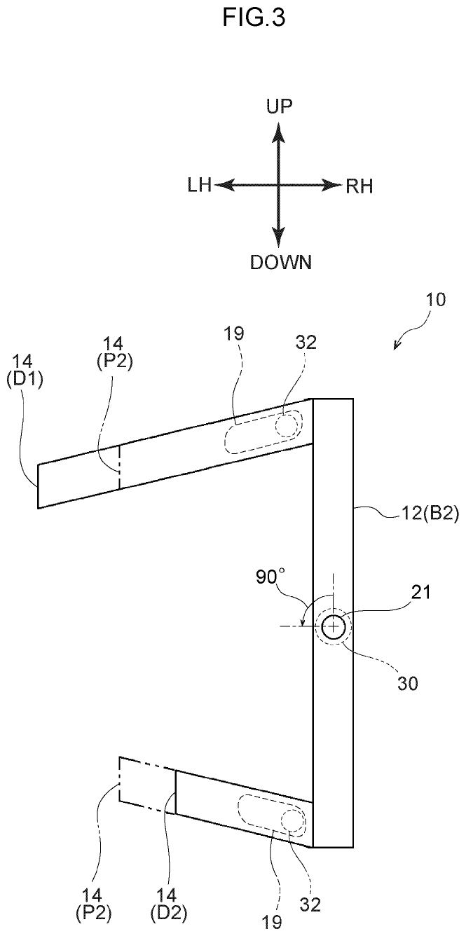

Further, as illustrated in FIG. 2, when the first displacement portion 12 is rotated 90° to the left side from the neutral position P1 (the first displacement portion 12 is disposed at the permitting position B2) due to the occupant of the vehicle inputting operational force to the pair of left and right second displacement portions 14 such that the second displacement portion 14 gripped by the right hand heads toward the upper side and the second displacement portion 14 gripped by the left hand heads toward the lower side, the steering angles and the like of the wheels toward the left side are controlled so as to become steering angles and the like that correspond to the angle of rotation (90° toward the left side) of the first displacement portion 12 from the neutral position P1 (that are based on the output value from the first sensor 30). Here, in the state in which the first displacement portion 12 has been rotated 90° to the left side, the extension/retraction locking portions 19 are in the permitting states, and extending and retracting of the second displacement portions 14 with respect to the first displacement portion 12 are permitted. When, from this state, the occupant of the vehicle inputs operational force to the pair of left and right second displacement portions 14 such that the second displacement portion 14 gripped by the right hand heads toward the left side and the second displacement portion 14 gripped by the left hand heads toward the right side, as illustrated in FIG. 3, the second displacement portion 14 gripped by the right hand extends, and the second displacement portion 14 gripped by the left hand retracts. Due thereto, the steering angles and the like of the wheels toward the left side are controlled so as to become steering angles and the like that correspond to the amount of extension of the second displacement portion 14 gripped by the right hand and the amount of retraction of the second displacement portion 14 gripped by the left hand (that are based on the output value from the first sensor 30 and the output values from the pair of left and right second sensors 32) (the steering angles and the like are controlled so as to increase with respect to the steering angles and the like of the state in which the first displacement portion 12 has been rotated 90° to the left side). Here, in the above-described case, the steering angles and the like of the wheels toward the left side may be controlled by adding only the output value from the second sensor 32, which corresponds to the amount of extension of the second displacement portion 14 gripped by the right hand, to the output value from the first sensor 30. Or, the steering angles and the like of the wheels toward the left side may be controlled by adding, to the output value from the first sensor 30, a value that is obtained by carrying out a predetermined computation on the output value from the second sensor 32 corresponding to the amount of extension of the second displacement portion 14 gripped by the right hand and the output value from the second sensor 32 corresponding to the amount of retraction of the second displacement portion 14 gripped by the left hand.

Further, when the first displacement portion 12 is rotated 90° to the right side from the neutral position P1 (the first displacement portion 12 is disposed at the permitting position B2) due to the occupant of the vehicle inputting operational force to the pair of left and right second displacement portions 14 such that the second displacement portion 14 gripped by the left hand heads toward the upper side and the second displacement portion 14 gripped by the right hand heads toward the lower side, the steering angles and the like of the wheels toward the left side are controlled so as to become steering angles and the like that correspond to the angle of rotation (90° toward the right side) of the first displacement portion 12 from the neutral position P1 (that are based on the output value from the first sensor 30). Here, in the state in which the first displacement portion 12 has been rotated 90° to the right side, the extension/retraction locking portions 19 are in the permitting states, and extending and retracting of the second displacement portions 14 with respect to the first displacement portion 12 are permitted. When, from this state, the occupant of the vehicle inputs operational force to the pair of left and right second displacement portions 14 such that the second displacement portion 14 gripped by the left hand heads toward the right side and the second displacement portion 14 gripped by the right hand heads toward the left side, the second displacement portion 14 gripped by the left hand extends, and the second displacement portion 14 gripped by the right hand retracts. Due thereto, the steering angles and the like of the wheels toward the right side are controlled so as to become steering angles and the like that correspond to the amount of extension of the second displacement portion 14 gripped by the left hand and the amount of retraction of the second displacement portion 14 gripped by the right hand (that are based on the output value from the first sensor 30 and the output values from the pair of left and right second sensors 32) (the steering angles and the like are controlled so as to increase with respect to the steering angles and the like of the state in which the first displacement portion 12 has been rotated 90° to the right side). Here, in the above-described case, the steering angles and the like of the wheels toward the right side may be controlled by adding only the output value from the second sensor 32, which corresponds to the amount of extension of the second displacement portion 14 gripped by the left hand, to the output value from the first sensor 30. Or, the steering angles and the like of the wheels toward the right side may be controlled by adding, to the output value from the first sensor 30, a value that is obtained by carrying out a predetermined computation on the output value from the second sensor 32 corresponding to the amount of extension of the second displacement portion 14 gripped by the left hand and the output value from the second sensor 32 corresponding to the amount of retraction of the second displacement portion 14 gripped by the right hand.

As described above, in the operation device 10 of the present embodiment, in the state in which the first displacement portion 12 is positioned at the permitting position B2 (the state in which rotation of the first displacement portion 12 toward the left side or the right side is restricted), the amounts of displacement, due to extending and retracting, of the second displacement portions 14 with respect to the first displacement portion 12 can be ensured. Further, in the operation device 10 of the present embodiment, due to extending and retracting of the second displacement portions 14 with respect to the first displacement portion being permitted in the state in which the first displacement portion 12 is positioned at the permitting position 132, the load on the vehicle occupant at the time of operation can be reduced. In particular, the load that is due to twisting of the hand (the wrist) that is located at the lower side can be reduced.

### Operation Device 22 Relating to Second Embodiment

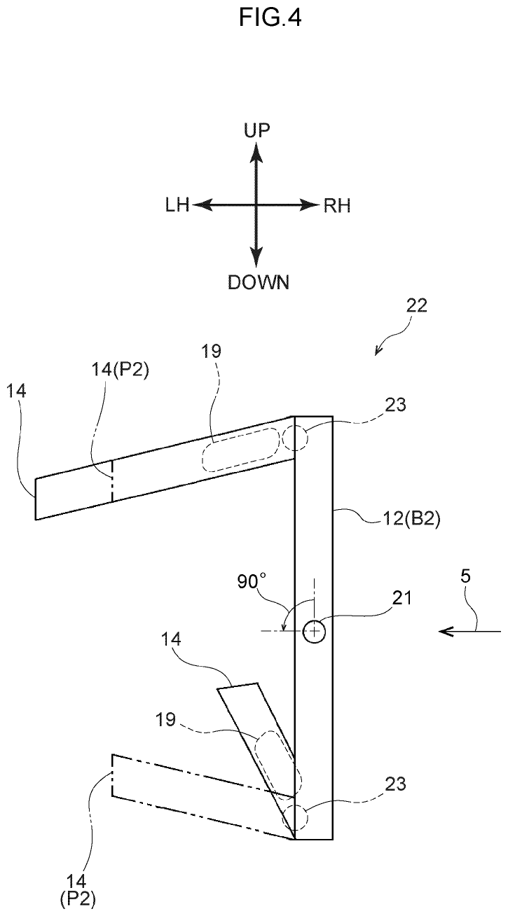

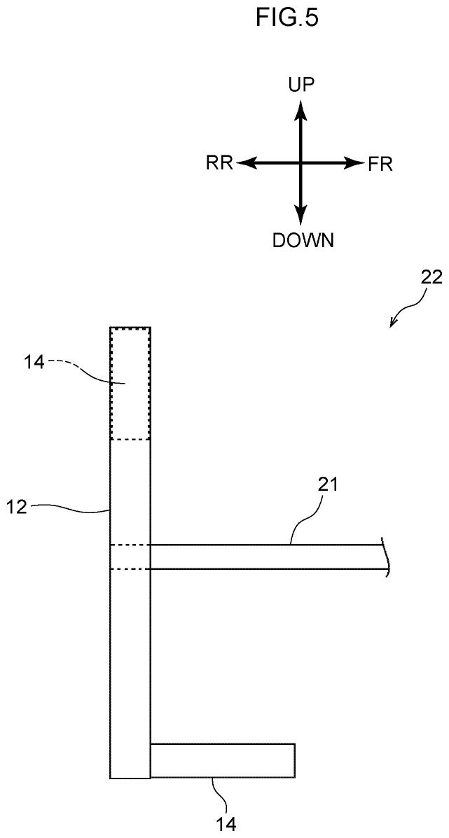

An operation device 22 relating to a second embodiment of the present invention is described by using FIGS. 4 and 5. Note that, at the operation device 22 relating to the second embodiment, members and portions corresponding to the operation device 10 relating to the above-described first embodiment are denoted by the same reference numerals as the members and portions corresponding to the operation device 10 relating to the first embodiment, and there are cases in which description thereof is omitted.

As illustrated in FIG. 4 and FIG. 5, in the operation device 22 of the present embodiment, in addition to the pair of left and right second displacement portions 14 being able to extend and retract toward the first displacement portion 12 side and the side opposite the first displacement portion 12, the pair of left and right second displacement portions 14 is tiltable toward the front side with respect to the first displacement portion 12. Further, the operation device 22 of the present embodiment has tilting locking portions 23 that serve as locking portions and permit or restrict the tilting of the second displacement portions 14 with respect to the first displacement portion 12.

The tilting locking portions 23 are provided, as an example, at the border between the left-side second displacement portion 14 and the first displacement portion 12, and at the border between the right-side second displacement portion 14 and the first displacement portion 12, respectively. These tilting locking portions 23 can be switched between two states that are a permitting state and a restricting state due to, as an example, the energization thereof being switched or the like. Further, at the time when the tilting locking portions 23 are in the permitting states, tilting of the second displacement portions 14 toward the front side with respect to the first displacement portion 12 is permitted. On the other hand, at the time when the tilting locking portions 23 are in the restricting states, tilting of the second displacement portions 14 toward the front side with respect to the first displacement portion 12 is restricted. Note that the switching between the permitting states and the restricting states of the tilting locking portions 23 may be switching by a mechanical structure and not an electrical structure.

Further, in the present embodiment, in the state in which the first displacement portion 12 has been rotated to the left side and is positioned at the permitting position B2, the extension/retraction locking portion 19 at the side of the second displacement portion 14 gripped by the right hand is in a permitting state, and the extension/retraction locking portion 19 at the side of the second displacement portion 14 gripped by the left hand is in a restricting state. Further, in this state, the tilting locking portion 23 at the side of the second displacement portion 14 gripped by the right hand is in a restricting state, and the tilting locking portion 23 at the side of the second displacement portion 14 gripped by the left hand is in a permitting state.

On the other hand, in the state in which the first displacement portion 12 has been rotated to the right side and is positioned at the permitting position B2, the extension/retraction locking portion 19 at the side of the second displacement portion 14 gripped by the left hand is in a permitting state, and the extension/retraction locking portion 19 at the side of the second displacement portion 14 gripped by the right hand is in a restricting state. Further, in this state, the tilting locking portion 23 at the side of the second displacement portion 14 gripped by the left hand is in a restricting state, and the tilting locking portion 23 at the side of the second displacement portion 14 gripped by the right hand is in a permitting state.

Further, in the state in which the first displacement portion 12 is positioned at the restricting position B1 (see FIG. 1) that is a position different than the permitting position B2, the pair of extension/retraction locking portions 19 are in the restricting states, and the pair of tilting locking portions 23 are in the restricting states.

### Operation and Effects of Present Embodiment

Operation and effects of the present embodiment are described next.

As an example, the above-described operation device 22 relating to the present embodiment can, in the same way as the operation device 10 relating to the first embodiment, be applied to operations for changing the traveling direction of the vehicle.

At the operation device 22 relating to the present embodiment, in the state in which the first displacement portion 12 has been rotated 90° to the left side (the first displacement portion 12 is positioned at the permitting position B2), the extension/retraction locking portion 19 at the side of the second displacement portion 14 gripped by the right hand is in a permitting state, and the extension/retraction locking portion 19 at the side of the second displacement portion 14 gripped by the left hand is in a restricting state. Further, in this state, the tilting locking portion 23 at the side of the second displacement portion 14 gripped by the tight hand is in a restricting state, and the tilting locking portion 23 at the side of the second displacement portion 14 gripped by the left hand is in a permitting state. When, from this state, the occupant of the vehicle inputs operational force to the pair of left, and right second displacement portions 14 such that the second displacement portion 14 gripped by the right hand heads toward the left side and the second displacement portion 14 gripped by the left hand heads toward the front side, the second displacement portion 14 gripped by the right hand extends from the position illustrated by the two-dot chain lines toward the position illustrated by the solid lines, and the second displacement portion 14 gripped by the left hand is tilted from the position illustrated by the two-dot chain lines toward the position illustrated by the solid lines. Due thereto, the steering angles and the like of the wheels toward the left side are controlled so as to become steering angles and the like corresponding to the amount of extension of the second displacement portion 14 gripped by the right hand and the amount of tilting of the second displacement portion 14 gripped by the left hand (the steering angles and the like are controlled so as to increase with respect to the steering angles and the like of the state in which the first displacement portion 12 has been rotated 90° to the left side).

Further, at the operation device 22 relating to the present embodiment, in the state in which the first displacement portion 12 has been rotated 90° to the right side (the first displacement portion 12 is positioned at the permitting position B2), the extension/retraction locking portion 19 at the side of the second displacement portion 14 gripped by the left hand is in a permitting state, and the extension/retraction locking portion 19 at the side of the second displacement portion 14 gripped by the right hand is in a restricting state. Further, in this state, the tilting locking portion 23 at the side of the second displacement portion gripped by the left hand is in a restricting state, and the tilting locking portion 23 at the side of the second displacement portion 14 gripped by the right hand is in a permitting state. When, from this state, the occupant of the vehicle inputs operational force to the pair of left and right second displacement portions 14 such that the second displacement portion 14 gripped by the left hand heads toward the right side and the second displacement portion 14 gripped by the right hand heads toward the front side, the second displacement portion 14 gripped by the left hand extends, and the second displacement portion 14 gripped by the right hand is tilted toward the front side. Due thereto, the steering angles and the like of the wheels toward the right side are controlled so as to become steering angles and the like corresponding to the amount of extension of the second displacement portion 14 gripped by the left hand and the amount of tilting of the second displacement portion 14 gripped by the right hand (the steering angles and the like are controlled so as to increase with respect to the steering angles and the like of the state in which the first displacement portion 12 has been rotated 90° to the right side).

As described above, in the operation device 22 of the present embodiment, in the state in which the first displacement portion 12 is positioned at the permitting position B2 (the state in which rotation of the first displacement portion 12 toward the left side or the right side is restricted), the amounts of displacement, due to extending/retracting and tilting, of the second displacement portions 14 with respect to the first displacement portion 12 can be ensured. Further, in the operation device 22 of the present embodiment, in the state in which the first displacement portion 12 is positioned at the permitting position B2, due to the extending/retracting of one of the second displacement portions 14 with respect to the first displacement portion 12 being permitted and the tilting of the other second displacement portion 14 with respect to the first displacement portion 12 being permitted, the load on the vehicle occupant at the time of operation can be reduced. In particular, the load that is due to twisting of the hand (the wrist) that is located at the lower side can be reduced.

### Operation Device 34 Relating to Third Embodiment

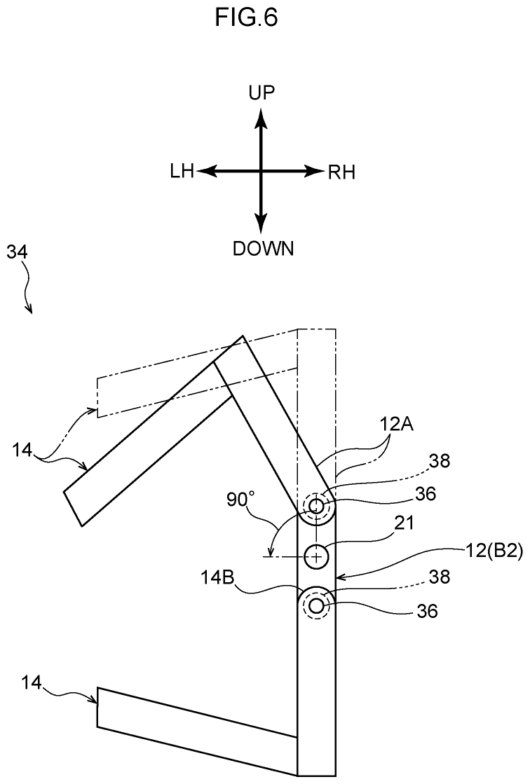

An operation device 34 relating to a third embodiment of the present invention is described by using FIG. 6. Note that, at the operation device 34 relating to the third embodiment, members and portions corresponding to the operation device 10 relating to the above-described first embodiment and the like are denoted by the same reference numerals as the members and portions corresponding to the operation device 10 relating to the first embodiment and the like, and there are cases in which description thereof is omitted.

As illustrated in FIG. 6, the operation device 34 of the present embodiment has the feature that the pair of left and right second displacement portions 14 that are formed in L-shapes can rotate with respect to the first displacement portion 12. Here, an end portion 14A at the first displacement portion 12 side of the second displacement portion 14 at the one side is connected via a pin 36 to one side of the portion, which is supported by the shaft 21, of the first displacement portion 12. Further, an end portion 14B at the first displacement portion 12 side of the second displacement portion 14 at the other side is connected via the pin 36 to the other side of the portion, which is supported by the shaft 21, of the first displacement portion 12. Due thereto, the pair of left and right second displacement portions 14 can rotate (tilt) with the pair of pins 36 being the centers of rotation thereof, respectively. Further, the folding, around the pins 36, of the pair of left and right second displacement portions 14 is restricted or permitted by a pair of folding locking portions 38 that serve as locking portions.

### Operation and Effects of Present Embodiment

Operation and effects of the present embodiment are described next.

The above-described operation device 34 relating to the present embodiment can, similarly to the operation device 10 relating to the first embodiment and the like, be applied to operations for changing the traveling direction of the vehicle.

At the operation device 34 relating to the present embodiment, in the state in which the first displacement portion 12 has been rotated 90° to the left side (the first displacement portion 12 is disposed at the permitting position B2), the folding locking portion 38 at the side of the second displacement portion 14 gripped by the right hand is in a permitting state, and the folding locking portion 38 at the side of the second displacement portion 14 gripped by the left hand is in a restricting state. When, from this state, the occupant of the vehicle inputs operational force to the pair of left and right second displacement portions 14 such that the second displacement portion 14 gripped by the right hand heads toward the left side and the second displacement portion 14 gripped by the left hand heads toward the right side, only the second displacement portion 14 that is gripped by the right hand rotates around the one pin 36 from the position illustrated by the two-dot chain lines toward the position illustrated by the solid lines. Due thereto, the steering angles and the like of the wheels toward the left side are controlled so as to become steering angles and the like that correspond to the amount of rotation of the second displacement portion 14 gripped by the right hand (the steering angles and the like are controlled so as to increase with respect to the steering angles and the like of the state in which the first displacement portion 12 has been rotated 90° to the left side).

Further, at the operation device 34 relating to the present embodiment, in the state in which the first displacement portion 12 has been rotated 90° to the right side (the first displacement portion 12 is disposed at the permitting position B2), the folding locking portion 38 at the side of the second displacement portion 14 gripped by the left hand is in a permitting state, and the folding locking portion 38 at the side of the second displacement portion 14 gripped by the right hand is in a restricting state. When, from this state, the occupant of the vehicle inputs operational force to the pair of left and right second displacement portions 14 such that the second displacement portion 14 gripped by the left hand heads toward the right side and the second displacement portion 14 gripped by the right hand heads toward the left side, only the second displacement portion 14 that is gripped by the left hand rotates around the another pin 36. Due thereto, the steering angles and the like of the wheels toward the right side are controlled so as to become steering angles and the like that correspond to the amount of rotation of the second displacement portion 14 gripped by the left hand (the steering angles and the like are controlled so as to increase with respect to the steering angles and the like of the state in which the first displacement portion 12 has been rotated 90° to the right side).

As described above, in the operation device 34 of the present embodiment, in the state in which the first displacement portion 12 is positioned at the permitting position B2 (the state in which rotation of the first displacement portion 12 toward the left side or the right side is restricted), the amount of displacement, due to rotation, of the second displacement portion 14 with respect to the first displacement portion 12 can be ensured. Further, in the operation device 34 of the present embodiment, in the state in which the first displacement portion 12 is positioned at the permitting position B2, due to rotation of one of the second displacement portions 14 with respect to the first displacement portion 12 being permitted and rotation of the other second displacement portion 14 with respect to the first displacement portion 12 being restricted, the load on the vehicle occupant at the time of operation can be reduced. In particular, the load that is due to twisting of the hand (the mist) that is located at the lower side can be reduced.

### Operation Device Relating to Fourth Embodiment

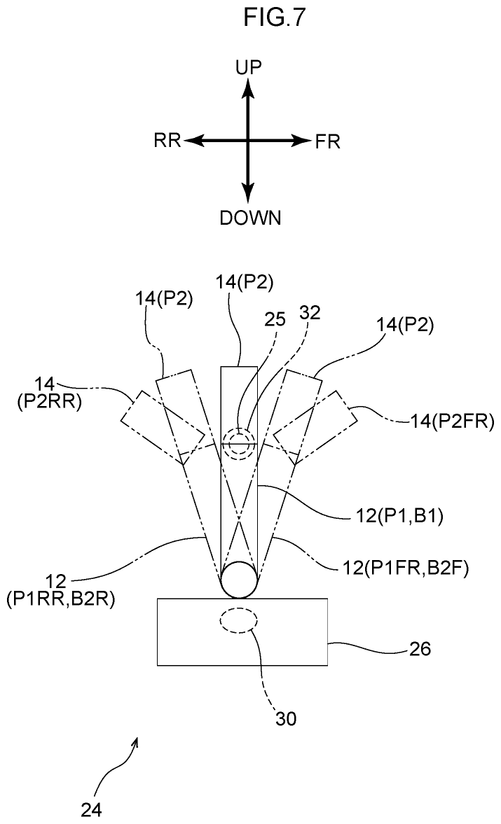

An operation device 24 relating to a fourth embodiment of the present invention is described next by using FIG. 7.

As illustrated in FIG. 7, the operation device 24 of the present embodiment has the first displacement portion 12 that is tiltable by being operated by an occupant of the vehicle, and the second displacement portion 14 that is tiltably supported at the first displacement portion 12. Further, the operation device 24 has a tilting locking portion 25 that serves as a locking portion and that permits or restricts tilting of the second displacement portion 14 with respect to the first displacement portion 12.

The first displacement portion 12 is formed in the shape of a rod that extends in the vertical direction. The lower end portion of the first displacement portion 12 is supported at a base portion 26 that has an unillustrated tilting mechanism. The first displacement portion 12 is tiltable in the longitudinal direction with respect to the base portion 26. Due thereto, the first displacement portion 12 is tiltable in the state in which the occupant of the vehicle grips the second displacement portion 14 that is described later. Note that the position of the first displacement portion 12 in the state in which the first displacement portion 12 is parallel to the vertical direction is called the neutral position P1. Further, in FIG. 7, the state in which the first displacement portion 12 is disposed at the neutral position P1 is illustrated by the solid lines, and position P1FR, at which the first displacement portion 12 is tilted furthest toward the front side, and position P1RR, at which the first displacement portion 12 is tilted furthest toward the rear side, are illustrated by the two-clot chain lines, respectively. Note that positions of the first displacement portion 12, which is in the state of being positioned at the neutral position P1, and in the range that is less than the position P1FR at which it is tilted furthest toward the front side from the neutral position P1, and in the range that is less than the position P1RR at which it is tilted furthest toward the rear side from the neutral position P1, are called the restricting position B1 that serves as the first position. Further, the position P1FR, at which the first displacement portion 12 is tilted furthest toward the front side, is called front-side permitting position B2F that serves as the second position. Moreover, the position P1RR, at which the first displacement portion 12 is tilted furthest toward the rear side, is called rear-side permitting position B2R that serves as the second position.

The second displacement portion 14 is supported at the upper end portion of the first displacement portion 12 via an unillustrated tilting mechanism so as to be able to tilt within a predetermined range in the longitudinal direction. Note that, in FIG. 7, the state in which the second displacement portion 14 is disposed at the neutral position P2 is illustrated by the solid lines, and position P2FR, at which the second displacement portion 14 is tilted furthest toward the front side with respect to the first displacement portion 12, and position P2RR, at which the second displacement portion 14 is tilted furthest toward the rear side with respect to the first displacement portion 12, are illustrated by the two-dot chain lines, respectively.

The tilting locking portion 25 is, as an example, provided integrally with the tilting mechanism that is tiltable the second displacement portion 14 with respect to the first displacement portion 12. This tilting locking portion 25 can be switched to three states that are a restricting state, a first permitting state and a second permitting state by, as an example, the electrification thereof being switched, or the like. Further, at the time when the tilting locking portion 25 is in the restricting state, tilting of the second displacement portion 14 with respect to the neutral position P2 is restricted. Further, at the time when the tilting locking portion 25 is in the first permitting state, tilting of the second displacement portion 14 toward the front side with respect to the neutral position P2 is permitted, and tilting of the second displacement portion 14 toward the rear side with respect to the neutral position P2 is restricted. Moreover, at the time when the tilting locking portion 25 is in the second permitting state, tilting of the second displacement portion 14 toward the rear side with respect to the neutral position P2 is permitted, and tilting of the second displacement portion 14 toward the front side with respect to the neutral position P2 is restricted. Further, in the present embodiment, in the state in which the first displacement portion 12 is disposed at the restricting position B1, the tilting locking portion 25 is in a restricting state. in the state in which the first displacement portion 12 is disposed at the front-side permitting position B2F, the tilting locking portion 25 is in the first permitting state. In the state in which the first displacement portion 12 is disposed at the rear-side permitting position B2R, the tilting locking portion 25 is in the second permitting state. Note that the switching between the restricting state, the first permitting state and the second permitting state of the tilting locking portion 25 may be switching by a mechanical structure and not an electrical structure.

### Operation and Effects of Present Embodiment

Operation and effects of the present embodiment are described next.

As an example, the above-described operation device 24 relating to the present embodiment can be applied to the following operations.

As illustrated in FIG. 7, in the state in which the first displacement portion 12 is disposed at the neutral position P1, the tilting locking portion 25 is in the restricting state, and tilting of the second displacement portion 14 with respect to the neutral position P2 is restricted. In this state, the transmission of the vehicle is in the neutral state, and power of the power unit of the vehicle cannot be transmitted to the wheels.

Further, in the state in which the first displacement portion 12 is disposed at the neutral position P1, when the occupant of the vehicle inputs operational force toward the front side to the second displacement portion 14, the first displacement portion 12 is tilted toward the front side. Then, in the state in which the first displacement portion 12 is disposed at the position P1FR at which it is tilted furthest toward the front side and the second displacement portion 14 is disposed at the neutral position P2, the transmission of the vehicle is in the state in which reversing is possible, and the vehicle can be reversed.

Further, in the state in which the first displacement portion 12 is disposed at the position P1FR at which it is tilted furthest toward the front side, the tilting locking portion 25 is in the first permitting state, and tilting of the second displacement portion 14 toward the front side with respect to the neutral position P2 is permitted, and tilting of the second displacement portion 14 toward the rear side with respect to the neutral position P2 is restricted. In this state, when the occupant of the vehicle inputs operational force toward the front side to the second displacement portion 14, the second displacement portion 14 is tilted toward the front side with respect to the first displacement portion 12. Further, in the state in which the second displacement portion 14 is disposed at the position P2FR at which it is tilted furthest toward the front side with respect to the first displacement portion 12, the electric parking brake of the vehicle is in an operated state, and movement of the vehicle is impossible. Note that, when, from this state, the occupant of the vehicle inputs operational force toward the rear side to the second displacement portion 14, the first displacement portion 12 is in a state of being disposed at the position P1FR at which it is tilted furthest toward the front side, and the second displacement portion 14 is tilted to as far as the neutral position P2. Further, when the occupant of the vehicle inputs operational force toward the rear side to the second displacement portion 14 that is positioned at the neutral position P2, the first displacement portion 12 is tilted toward the neutral position P1.

On the other hand, when, in the state in which the first displacement portion 12 is disposed at the neutral position P1, the occupant of the vehicle inputs operational force toward the rear side to the second displacement portion 14, the first displacement portion 12 is tilted toward the rear side. Further, in the state in which the first displacement portion 12 is disposed at the position P1RR at which it is tilted furthest toward the rear side and the second displacement portion 14 is disposed at the neutral position P2, the transmission of the vehicle is in a state in which forward advancing is possible, and the vehicle can advance forward.

Further, in the state in which the first displacement portion 12 is disposed at the position P1RR at which it is tilted furthest toward the rear side, the tilting locking portion 25 is in the second permitting state, and tilting of the second displacement portion 14 toward the rear side with respect to the neutral position P2 is permitted, and tilting of the second displacement portion 14 toward the front side with respect to the neutral position P2 is restricted. In this state, when the occupant of the vehicle inputs operational force toward the rear side to the second displacement portion 14, the second displacement portion 14 is tilted toward the rear side with respect to the first displacement portion 12. Then, in the state in which the second displacement portion 14 is disposed at the position P2RR at which it is tilted furthest toward the rear side with respect to the first displacement portion 12, the transmission of the vehicle is in a power mode or an eco mode, and the transmission of the vehicle is shifted down or shifted up so as to become a lower gear ratio or a higher gear ratio. Note that, when, from this state, the occupant of the vehicle inputs operational force toward the front side to the second displacement portion 14, in the state in which the first displacement portion 12 is disposed at the position P1RR at which it is tilted furthest toward the rear side, the second displacement portion 14 is tilted to as far as the neutral position P2. Further, when the occupant of the vehicle inputs operational force toward the front side to the second displacement portion 14 that is positioned at the neutral position P2, the first displacement portion 12 is tilted toward the neutral position P1.

As described above, in the operation device 24 of the present embodiment, in the state in which the first displacement portion 12 is disposed at the position P1FR at which it is tilted furthest toward the front side or in the state in which the first displacement portion 12 is disposed at the position P1RR at which it is tilted furthest toward the rear side (states in which tilting of the first displacement portion 12 toward the front side or the rear side is restricted), the amount of displacement, due to tilting, of the second displacement portion 14 with respect to the first displacement portion 12 can be ensured. Further, in the operation device 24 of the present embodiment, in the state in which the first displacement portion 12 is disposed at the position P1FR at which it is tilted furthest toward the front side or in the state in which the first displacement portion 12 is disposed at the position P1RR at which it is tilted furthest toward the rear side, by permitting the tilting of the second displacement portion 14 with respect to the first displacement portion 12, the load on the vehicle occupant at the time of operation can be reduced. In particular, the load for tilting the first displacement portion 12 can be reduced.

Note that, although examples have been described in which the operation devices 10, 22 relating to the first embodiment and the second embodiment are used as operation devices that carry out operations for changing the orientation of a vehicle, the present invention is not limited to this. For example, the operation devices 10, 22 relating to the first embodiment and the second embodiment may be used as operation devices that carry out operations for shifting gears or the like such as in the operation device 24 relating to the fourth embodiment. Further, the operation devices 10, 22 relating to the first embodiment and the second embodiment may be used as operation devices that carry out operations for shifting gears or the like such as in the operation device 24 relating to the fourth embodiment. Further, the structures of the respective embodiments may be combined together.

Although embodiments of the present invention have been described above, the present invention is not limited to the above, and, of course, can be implemented by being modified in various ways other than the above, within a scope that does not depart from the gist thereof.

The disclosure of Japanese Patent Application No. 2020-38116 filed on Mar. 5, 2020 is, in its entirety, incorporated by reference into the present specification.

1. An operation device comprising:
a first displacement portion that is displaceable by being operated by an occupant of a vehicle;
a second displacement portion that is supported at the first displacement portion, and that is displaceable with respect to the first displacement portion by being operated by an occupant of the vehicle; and
a locking portion that, in a state in which the first displacement portion is positioned at a first position, restricts displacement of the second displacement portion with respect to the first displacement portion, and, in a state in which the first displacement portion is positioned at a second position, permits displacement of the second displacement portion with respect to the first displacement portion.

2. The operation device of claim 1, wherein:
the first displacement portion is rotatably supported, and
the second displacement portion is supported at the first displacement portion so as to be able to be displaced toward the first displacement portion side and a side opposite the first displacement portion.

3. The operation device of claim 2, wherein:
a pair of second displacement portions, which are grasped by a left hand and a right hand of an occupant of the vehicle respectively, are supported at the first displacement portion in states of being able to extend and retract,
in a state in which the first displacement portion has been rotated toward one side from the first position and the first displacement portion is positioned at the second position, one of the second displacement portions is extendable, and another of the second displacement portions is retractable, and
in a state in which the first displacement portion has been rotated toward another side from the first position and the first displacement portion is positioned at the second position, the other of the second displacement portions is extendable, and the one of the second displacement portions is retractable.

4. The operation device of claim 2, wherein:
a pair of second displacement portions, which are grasped by a left hand and a right hand of an occupant of a vehicle respectively, are supported at the first displacement portion in states of being able to extend and retract and being able to tilt,
in a state in which the first displacement portion has been rotated toward one side from the first position and the first displacement portion is positioned at the second position, one of the second displacement portions is extendable, and another of the second displacement portions is tiltable, and
in a state in which the first displacement portion has been rotated toward another side from the first position and the first displacement portion is positioned at the second position, the other of the second displacement portions is extendable, and the one of the second displacement portions is tiltable.

5. The operation device of claim 2, wherein:
a pair of second displacement portions, which are grasped by a left hand and a right hand of an occupant of a vehicle respectively, are supported at the first displacement portion in states of being able to tilt,
in a state in which the first displacement portion has been rotated toward one side from the first position and the first displacement portion is positioned at the second position, one of the second displacement portions is tiltable, and
in a state in which the first displacement portion has been rotated toward another side from the first position and the first displacement portion is positioned at the second position, another of the second displacement portions is tiltable.

6. The operation device of claim 1, wherein:
the first displacement portion is tiltably supported, and
the second displacement portion is tiltably supported at the first displacement portion.

7. The operation device of claim 6, wherein:
in a state in which the first displacement portion has been tilted toward one side from the first position and the first displacement portion is positioned at the second position, the second displacement portion is tiltable toward one side, and
in a state in which the first displacement portion has been tilted toward another side from the first position and the first displacement portion is positioned at the second position, the second displacement portion is tiltable toward another side.

8. The operation device of claim 1, further comprising a first sensor that detects an amount of displacement of the first displacement portion, and a second sensor that detects an amount of displacement of the second displacement portion with respect to the first displacement portion,
wherein, in a state in which the first displacement portion is positioned at the second position, values corresponding to an output value of the first sensor and an output value of the second sensor are added together.
